(19) United States
(12) Patent Application Publication
(10) Pub. No.: US 2009/0144021 A1
(43) Pub. Date: Jun. 4, 2009

(54) Long Range Mobile Communication Enabled Personal Weighing Device

(75) Inventor: Andras Ketskes, Szekesfehervar (HU)

Correspondence Address: Andras Ketskes, Suto u. 32, Szekesfehervar, 8000, HU

(73) Assignee: Andras Ketskes, Szekestebervar (HU)

(21) Appl. No.: 12/264,255

(22) Filed: Nov. 4, 2008

Related U.S. Application Data
(60) Provisional application No. 60/985,278, filed on Nov. 4, 2007.

(51) Int. Cl. G01G 9/00; G06F 15/00

(52) U.S. Cl. 702/173; 702/188

(57) ABSTRACT

A device and method for measuring a person's weight and transmitting the measurement results to a remote data center for storage and processing are disclosed. The measuring apparatus comprising a sensor unit, a processor unit and a communication module capable of transceiving data over a long range mobile communication network.

### BACKGROUND OF THE INVENTION

This invention relates to digital scales. Conventional personal scales provide prompt information regarding one's weight. This information however is rarely useful on it's own. It requires the context of previous measurements to enable effective tracking of one's weight for dietary, therapeutic or other purposes. Keeping a record of measurements is a tedious and burdensome exercise that is thereby often neglected.

### SUMMARY OF THE INVENTION

The primary object of this invention is to extend a conventional digital scale with data transmission capabilities to enable measurement data to be transmitted to a central storage system for record keeping, display and further analysis.

Another object is to enable a scale with a data transmission system, that doesn't require more interaction or attention from the user, than a conventional digital scale would.

A further object is to make use of a communication network that is already available and the use of which doesn't necessitate the installation of any hardware or the use of any software (on the users computer or elsewhere) in order to operate.

Other objects and advantages reside in the detailed description of the invention, which is designed to be simple, economic and most importantly easy to use.

### FIGURES OF THE DRAWING

FIG. 1 is a block diagram of the main components of a conventional digital scale

FIG. 2 is a block diagram of the main components of an extended digital scale described by this invention (dashed lines showing the additional components)

FIG. 3 is a flowchart of the main steps to be taken by the program running on the microcontroller of an conventional digital scale

FIG. 4 is a flowchart of the main steps to be taken by the program running on the microcontroller of an extended digital scale described by this invention (dashed lines showing the additional steps)

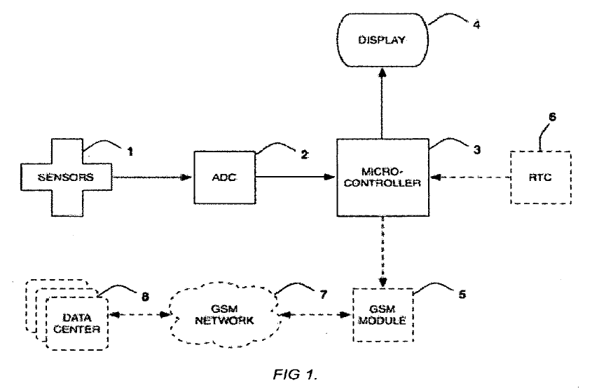

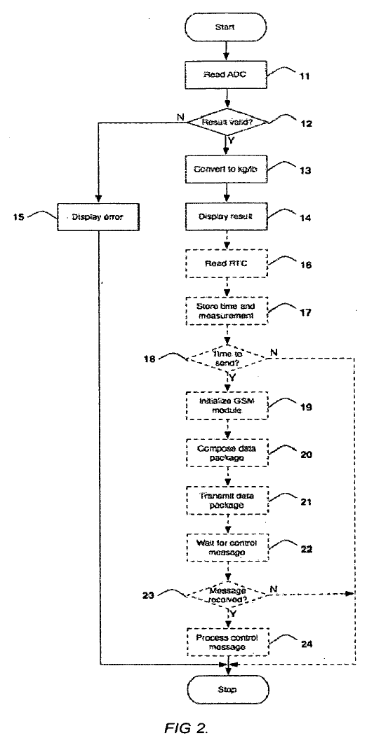

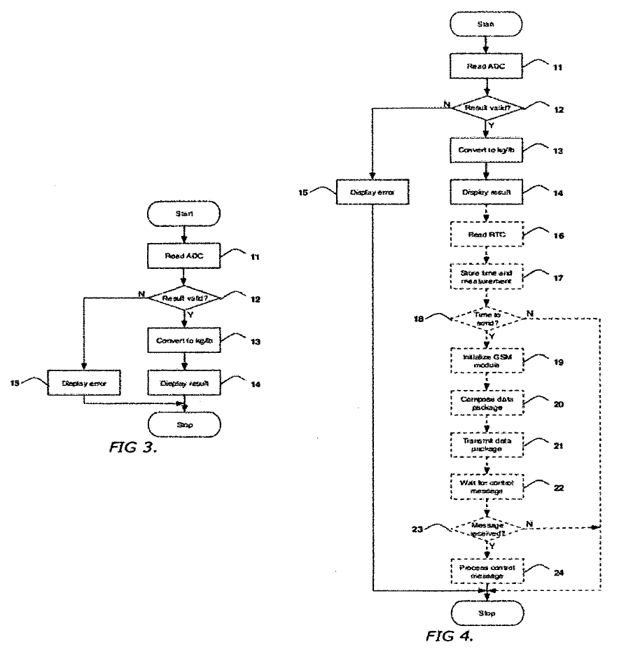

### DESCRIPTION OF THE ELCETRONIC HADWARE

Conventional digital scales include a network of strain gauge sensors (including the necessary amplifier circuit) 1 connected to an ADC (analog/digital converter) 2, a microcontroller 3 and a display 4. The ADC 2 may be integrated into the microcontroller 3.

The scale of this invention is extended by an embeddable GSM module 5 to handle all network 7 related activities and an RTC (realtime clock) 6 to keep track of the passing of time. The GSM module 5 may already indude an RTC 6, in this case that may be used. The microcontroller 3 used, handling the output of the analog/digital conversion 2 and driving the display 4 must also control the GSM module 5 and the communication (see software). This is likely to necessitate a device with more resources (memory, computing power etc.) than the ones used in conventional digital scales.

The GSM [Global System for Mobile communications; originally: Groupe Special Mobile] network 7 is chosen as a means of communication as it is becoming the global standard for mobile communication and an integrated module inside the scale requires no further components to be installed or actions to be taken by the user.

### DESCRIPTION OF THE SOFTWARE CONTROLLING THE OPERATION

Conventional digital scales take a measurement form the ADC 11 and check whether it's valid 12. In case it is, the input data from the ADC 2 is converted into the desired measurement units (kg, lb etc.) 13 and the display is driven to show the result 14. If input data is invalid, an error is displayed 15.

After displaying the result 14, the extended software of this invention's scale takes a timestamp from the RTC 16 and stores both the result and the timestamp in memory 17. Once a valid measurement is taken, the system must evaluate if a data package is to be sent 18. This is decided based on the time the previous package was sent. In order to reduce communication costs, the system doesn't send packages for a specified interval after the last one was sent. The software running on the microcontroller 3 has only limited resources and information to decide if a measurement was valid or not, so if the result read from the ADC 2 is stable and within the physical measurement range, it is considered valid. Previous measurements (at least the ten most recent suggested) must thereby be retained and induded in every data package, in case a false valid result triggered a transmission. This also allows for limited backup functionality, in case the data center did not succeed in processing or storing previous data packages. If a data package is to be sent, the GSM module 5 must be initialized and instructed to connect to the network 7 19, the data package has to be composed from the timestamped measurement results and additional data (see Description of the data package) 20 and it has to be transmitted over the network in the from of SMS text message(s) [Short Message Service (defined by the GSM specification)] or IP [Internet Protocol (defined in RFC791 and others)] packet(s) sent over GPRS [General Packet Radio Service (defined by the GSM specification)] or any other means provided by the network 21. After the transmission the system must idle for a short time, while remaining connected 22 in order to allow time for the GSM network 7 to deliver a control message sent by the data center 8, in case it wishes to change a parameter in the scale (e.g. destination of future data packets, time between data packets etc.). If a control message is received 23 the system must process it and act accordingly (e.g. modify the parameters required) 24.

### DESCRIPTION OF THE DATA PACKAGE

The data package mainly contains the timestamped measurement results. It must also contain the unique identifier of the scale and may also contain other parameters (e.g. battery voltage level) to enable other functionalities (e.g. statistical data collection, to provide feedback to the user etc.).

As the scale does not necessarily have the means to keep track of absolute time (it depends on the capabilities of the GSM module, network services etc.), relative time is used to identify results. The RTC 6 is started in the device as it is powered on and runs oontinuously. The relative time it provides is used to timestamp results. Upon composition (immediately before transmission), the data package must also be timestamped in the same manner. SMS text messages have an absolute timestamp attached to them by the network showing the time of transmission. IP packets however, don't need such timestamp as they are delivered almost instantaneously, so the data center's absolute clock can be used as reference. Using the difference between the data package's relative timestamp and the measurements relative timestamp and the absolute time of transmission, each measurements' absolute time can be calculated upon processing in the data center:
measmt_absTs=pckg_absTs−(pckg_relTs−measmt relTs),
   where measmt_absTs is the measurement's absolute timestamp, Measmt_relTs is the measurement's relative timestamp, pckg_absts is the data package's absolute time of transmission and pckg_relTs is the data package's relative timestamp.

Measurement results and additional data should be encrypted in order to protect the user's privacy, authenticate the sender scale and prevent tampering with the data.

### DATA CENTER

The data center must have the necessary communication infrastructure to terminate data packages sent by the scales and to send control messages to them. This may be a terminal or gateway attached directly to the GSM network or a gateway/conversion service (e.g. from GSM-SMS to HTTP

[Hypertext Transfer Protocol (defined in RFC2616 and others)]) provided by a third party or the network operator itself.

Upon processing, the measurement results and absolute timestamps must be stored in a database. The data center should use previous data (if available) to filter out invalid measurements falsely considered valid by the scale. A simple implementation of such a filter would be to compare the currently received measurement to the previous ones and discard it if the difference between them is above a certain threshold. This threshold may be adjusted based on the time between the two measurements. If additional data was sent in the package, they may be used for their desired purposes.

Control messages may be sent by the data center if the scales' behavior is to be changed. Such changes may be (but are not limited to) data package transmission interval, destination of data packets etc. Control messages shall be encrypted to authenticate the data center and to prevent third parties from tampering with the scale's settings.

### INTERFACE

Data stored in the database is represented on charts and may be fed into analytical algorithms for further processing. The charts are incorporated into a website, allowing detailed examination of the measurements over time. Using additional data (e.g. age, height etc.) BMI [Body Mass Index or Quetelet index (developed by Adolphe Quetelet)] and other attributes can be calculated and represented as a time sequence, too. Goals may also be set to be represented in the charts and generate warnings and messages to users. Charts and messages may also be delivered by other means (e.g. MMS [Multimedia Messaging Service (defined by 3GPP, 3GPP2 and Open Mobile Alliance—OMA)], e-mail, applications, widgets [small applications found in recent operating systems (widgets in Mac OS X, gadgets in Microsoft Windows Vista etc.)] etc.).

Additional algorithms may be used to further analyze the data and provide feedback to the user (dietary advice, suggestions for exercise etc).

1. An apparatus for monitoring a person's weight, said apparatus comprising: a weight sensor; a processor unit coupled to said weight sensor; and a communication unit coupled to said processor unit capable of connecting to a long range mobile communication network wherein said communication unit enables said apparatus to send measurement results to and receive control messages from a remote data center.

2. A method of measuring and transmitting a person's weight, said method comprising the steps of: providing an apparatus for an individual to obtain measurements for said individual's weight; transmitting said measurements to a remote data center through a long range mobile communication network; and said remote data center optionally sending a control message or messages through said long range mobile communication network to said apparatus.
